(19) United States
(12) Patent Application Publication
(10) Pub. No.: US 2012/0259768 A1
(43) Pub. Date: Oct. 11, 2012

(54) SYSTEM AND METHOD FOR PROVIDING PROXY ACCOUNTS

(75) Inventor: Partha Sarathi Mukherjee, San Jose, CA (US)

(73) Assignee: eBay Inc., San Jose, CA (US)

(21) Appl. No.: 13/080,308

(22) Filed: Apr. 5, 2011

(51) Int. Cl. G06Q 40/00

(52) U.S. Cl. 705/39

(57) ABSTRACT

In various example embodiments, a system and method for providing a proxy account is provided. A transaction request initiated through a proxy account is received. The proxy account is a dependent, non-funded subaccount of a master account. A determination of whether a transaction of the transaction request satisfies restrictions and an amount limit established for the proxy account is performed. Based on the transaction satisfying the restrictions and the amount limit, the transaction is processed against a funding instrument of the master account.

### FIELD

The present disclosure relates generally to accounts, and in a specific example embodiment, to providing proxy accounts.

### BACKGROUND

A financial account allows a user to transfer and receive funds. The transferring or receipt of funds may be associated with a purchase of an item, loan between individuals, payment of a bill, or any other transaction that involves the exchange of funds. The financial account may be funded by a linked bank account, credit card, or any other form of a financial instrument.

### BRIEF DESCRIPTION OF DRAWINGS

Various ones of the appended drawings merely illustrate example embodiments of the present invention and cannot be considered as limiting its scope.

FIG. 1 is a block diagram illustrating an example environment in which embodiments of a system to provide proxy accounts may be used.

FIG. 2 are block diagrams illustrating examples of proxy account scenarios.

FIG. 3 is a block diagram illustrating an example embodiment of a payment system.

FIG. 4 is a flow diagram of an example high-level method for creating a proxy account.

FIG. 5 is a flow diagram of an example method for receiving and validating proxy account setup information.

FIG. 6 is a flow diagram of an example method for processing a transaction initiated by a proxy account.

FIG. 7 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

As used herein, the term “or” may be construed in either an inclusive or exclusive sense. Additionally, although various example embodiments discussed below focus on a payment environment, the embodiments are given merely for clarity in disclosure. Thus, any type of electronic publication, electronic commerce, or electronic business system and method, including various system architectures, may employ various embodiments of the content system and method described herein and be considered as being within a scope of example embodiments. Each of a variety of example embodiments is discussed in detail below.

Example embodiments described herein provide systems and methods to provide proxy accounts. A proxy account is an account linked to a primary or master account, whereby transactions of the proxy account may be processed through a funding instrument of the master account. In example embodiments, the master account may be an online payment account (e.g., PayPal® account). The proxy account functions as a restricted miniature version or subaccount account (e.g., a shell) of the master account, and allows a user or owner of the master account to set up options that restrict the usage of the proxy account such that liability of the master account may be limited. The proxy account may have limits or restrictions on, for example, an amount allowed to be spent, time period of validity of the proxy account, access rights to view history, and access rights to add and delete further financial instruments. Thus, the proxy account is a dependent, non-funded subaccount of the master account that provides a partial view of the master account.

In example embodiments, the proxy account, itself, is not funded. Instead, any transactions initiated using the proxy account is processed through the master account. Therefore, the funding instruments of the master account are used to complete any transactions initiated by the proxy account. Thus, the proxy account allows a user to use the master account only in a manner allowed by the master account owner.

The proxy account may be established for any user. For example, the owner of the master account may want to purchase an item on the Internet, but is unsure of the seller or safety of the selling website. The owner may establish a proxy account for an amount of the intended purchase and set an expiration factor (e.g., expiration date) of the proxy account for enough time for the seller to complete the transaction (e.g., three days). The owner may then use the proxy account to transact the purchase and the liability attached to the proxy account is limited to the established amount. If the proxy account is compromised, the main account is generally protected and may only be liable for up to the established amount of the proxy account.

In another example, the owner of the master account may be an organization that wants to give their employees a bonus. In this case, the owner (e.g., an authorized entity of the organization) may establish a proxy account for each of their employees. The proxy accounts may all be assigned a same amount limit or have varying amount limits (e.g., a more senior employee may receive a larger bonus). As such, any number of proxy accounts may be established from a master account, and the limitations and restrictions assigned to each proxy account may vary.

In yet another example, the owner of the master account may establish a proxy account for their child (e.g., a student account). In this example, the owner may set restrictions on the amount that can be spent in certain categories or bar other categories for which the proxy account may not be used. As illustrated, one or more proxy accounts may be established for the use of the owner or for any other individual to which the owner wants to provide a proxy account.

In various example embodiments, a system and method for providing a proxy account is provided. A transaction request initiated through a proxy account is received. The proxy account is a subaccount of a master account. A determination of whether a transaction of the transaction request satisfies restrictions and an amount limit established for the proxy account is performed. Based on the transaction satisfying the restrictions and the amount limit, the transaction is processed against a funding instrument of the master account.

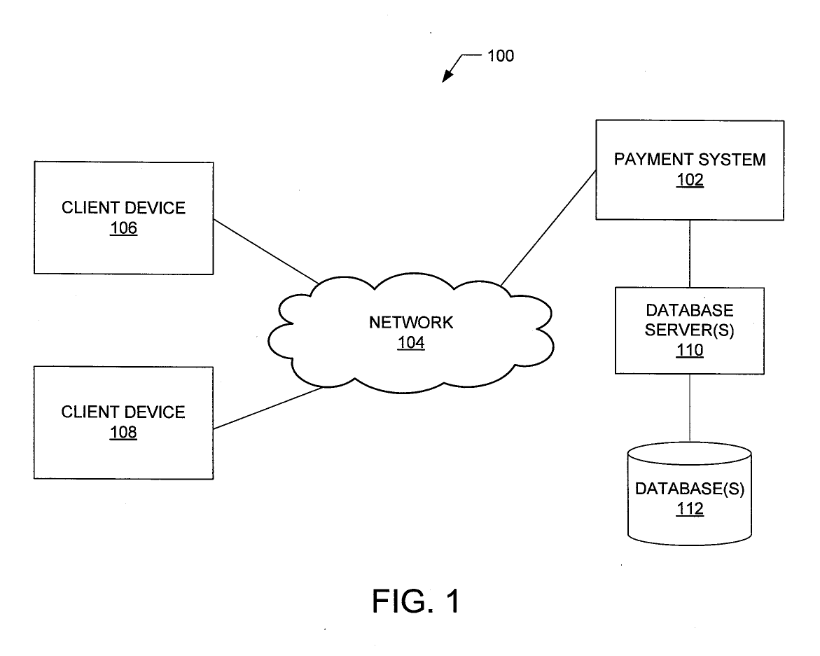

With reference to FIG. 1, an example embodiment of environment 100 in which proxy accounts may be used is shown. A payment system 102 is coupled to a communication network 104 (e.g., the Internet, wireless network, cellular network, or a Wide Area Network (WAN)). One or more client devices 106 and 108 are also coupled to the communication network 104. Each of the client devices 106 and 108 may comprise a browser (e.g., such as the INTERNET EXPLORER® browser) that allows the client device 106 and 108 to communicate with the payment system 102 via the communication network 104.

The payment system 102 may comprise one or more modules, applications, or engines, each of which may be embodied as hardware, software, firmware, or any combination thereof. The payment system 102 may be coupled to or comprise one or more database servers 110 facilitating access to one or more information storage repositories or database(s) 112. In one embodiment, the databases 112 may comprise a knowledge database that is updated with content, user preferences, and user transactions.

The payment system 102 provides a number of payment services and functions to users. The payment system 102 allows users to accumulate value (e.g., in a commercial currency, such as the U.S. dollar, or a proprietary currency, such as “points”) in accounts, and then later to redeem the accumulated value for products (e.g., goods or services) that are made available via various systems (e.g., network-based commerce system or brick and mortar store). The payment system 102 also facilitates payments from a payment mechanism or funding instrument (e.g., a bank account, PayPal, or credit card) for purchases of items, to settle invoices or bills, or for transfer of funds for other reasons.

Each client device 106 and 108 may be used by one or more users to perform functionalities associated with the payment system 102. The client devices 106 and 108 may comprise a mobile phone, desktop computer, laptop, or any other communication device that a user may utilize to access the payment system 102. In some embodiments, the client device 106 may also comprise one or more of a voice recognition module (not shown) to receive audio input, a touchscreen to receive tactile input, an accelerometer, GPS, or a display module (not shown) to display information (e.g., in the form of user interfaces).

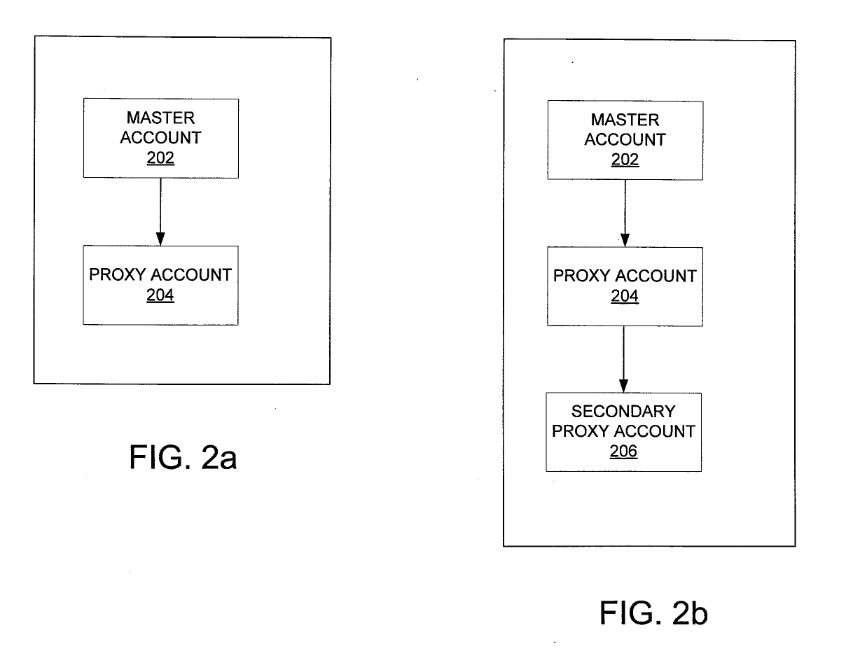

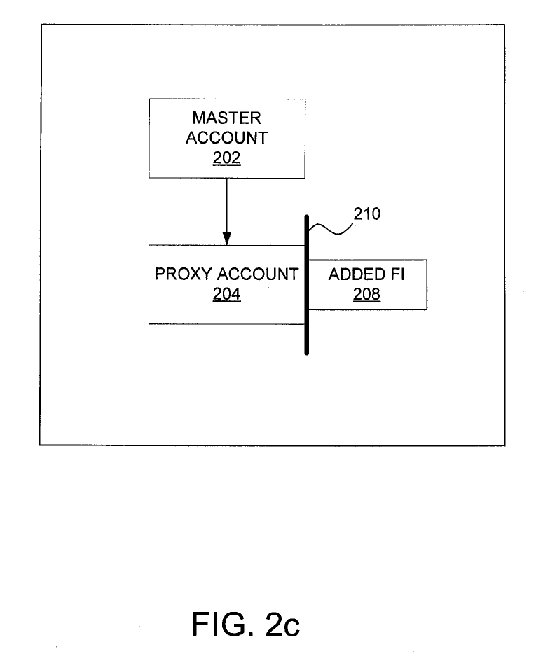

FIG. 2 illustrates block diagrams showing examples of proxy account scenarios. In FIG. 2a, an owner of a master account 202 establishes a proxy account 204. In one example, the proxy account 204 may be established for the use of the owner of the master account 202. For example, the owner may be traveling to a foreign country and wants to protect the master account 202 from being compromised. The owner may establish the proxy account 204 with a spending amount limit (e.g., $500) and with an expiration time (e.g., duration of the trip). Furthermore, the owner may establish a different proxy account for each country or currency. While only one proxy account 204 is shown, any number of proxy accounts 204 may be established off of the master account 202.

In another example, the proxy account 204 is established with a reoccurring limit that resets after a predetermined time period (e.g., $500 a month) with $200 restricted for particular use. In this example, the proxy account 204 may be established for a child of the master account owner. As such, the child is allowed to spend up to $500 a month. If the child attempts to spend more than $500, the excess charges are denied. However, if the child spends less than $500, the under-usage does not roll over. Of the $500, $200 may be restricted for use in certain categories. For example, the $200 may only be used to pay for rent, food, books, or tuition. It should be noted, that general restrictions may also be assigned to the proxy account. For example, the general restriction may bar the child from purchasing alcohol or cigarettes or from shopping at certain locations or with certain merchants.

The proxy account may be established with an expiration time (e.g., a date or a duration). For example, the expiration time may be set for when the child graduates from college. The proxy account will automatically expire without the owner having to perform any actions. As such, conditions of the proxy account 204 may be established upfront rather than having to change conditions later (e.g., closing of the account).

FIG. 2b illustrates an example whereby a secondary proxy account 206 is established from the proxy account 204. For example, the owner of the master account 202 may establish the proxy account 204 for their child. In this case, the proxy account 204 may be given a limit of $700 a month. The child, who is the user or owner of the proxy account 204, may establish the secondary proxy account 206, for example, to automatically pay their rent. Thus, the secondary proxy account 206 may be established for the child's landlord. As such, the landlord may initiate a transaction to remove a rent payment (e.g., $500 a month) from the secondary proxy account 206. The transaction is processed through the master account 202 and the funding instruments of the master account 202 are debited. While only one secondary proxy account 206 is shown, any number of secondary proxy accounts 206 may be established off of a proxy account 204 by the owner of the proxy account 204. Additionally, any number of lower level proxy accounts may be established off of an existing proxy account by the immediate owner of the proxy account. For example, a tertiary proxy account may be established off of a secondary proxy account (by the secondary proxy account owner), a quaternary proxy account may be established off of a tertiary proxy account (by the tertiary proxy account owner), and so on. For simplicity of discussion, a proxy account establishing a lower level proxy account may be referred to as the master account of the lower level proxy account.

FIG. 2c illustrates an example whereby the owner of the proxy account 204 is allowed to link their own funding instrument 208 to the proxy account, assuming access rights are set to allow the proxy account owner to add their own funding instruments. As discussed, the proxy account 204 is a non-funded, dependent sub-account of the master account 202. However, in some embodiments, the proxy account owner may be allowed to link their own funding instrument to their proxy account 204 in order to supplement the proxy account 204. The supplemental funding instrument 208 may be any one or more of a bank account, credit card, debit card, PayPal account, or other funding mechanism that corresponds to the owner of the proxy account. By linking the supplemental funding instrument 204 to the proxy account 204, the proxy account now comprises an independent funded portion that is separate from the dependent non-funded portion.

For example, the owner of the master account 202 may have established the proxy account 204 for use by another (e.g., child, employee) with a particular amount limit (e.g., $100). The amount limit may not be enough for the owner of the proxy account 204 to purchase a particular item (e.g., a $150 item). As such, the owner of the proxy account 204 may add their own funding instrument 208 to supplement the amount limit. When the transaction to purchase the item is initiated using the proxy account 204, the amount limit (e.g., $100) is processed through the funding instrument of the master account 202. The remaining amount (e.g., the remaining $50) is processed against the supplemental funding instrument 208 of the proxy account.

The owner of the proxy account 204 may set up a shield 210 for the supplemental funding instrument 208, which prevents the owner of the master account from accessing information related to the supplemental funding instrument 208. The shield 210 essentially separates out the proxy account owner portion from the master account funded portion of the proxy account. For example, if a child adds the supplemental funding instrument 208, then information on the supplemental funding instrument 208 and transactions completed using the supplemental funding instrument 208 may be shielded from the parent. The child has access rights to their own funding instrument 208 and any transactions performed using their supplemental funding instrument 208. In further embodiments, the owner of the proxy account may convert their proxy account into a master account by linking a funding instrument to their account and separating the account from the master account (e.g., removing the link to the master account such that transactions will no longer be processed through the funding instrument of the master account).

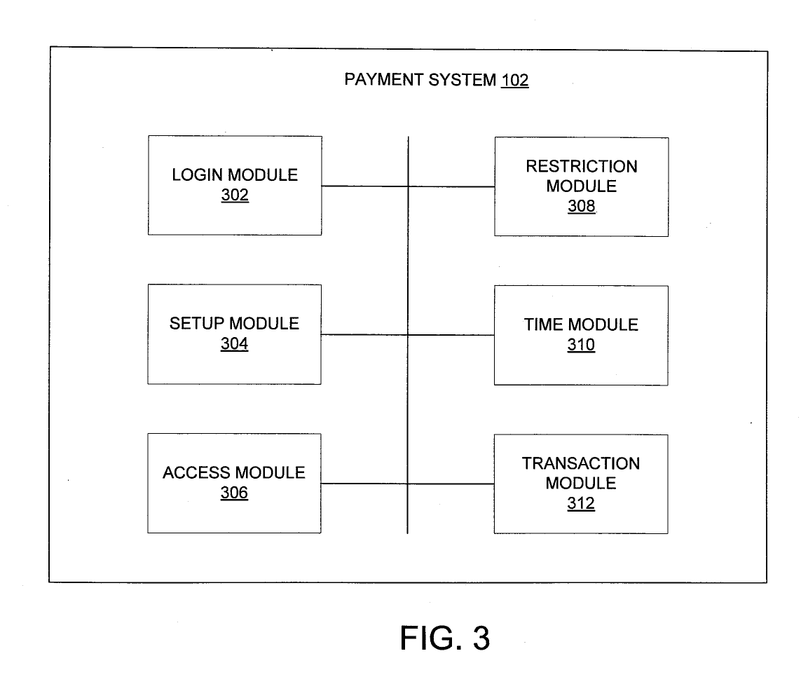

FIG. 3 is a block diagram illustrating an example embodiment of the payment system 102. The payment system 102 may be embodied, for example, on one or more servers and comprise a login module 302, a setup module 304, an access module 306, a restriction module 308, a time module 310, and a transaction module 312 communicatively coupled together. The modules may be embodied as hardware, software, firmware, or any combination thereof. In some embodiments, the functions of some of the modules may be combined into a single module. Alternatively, the functions of a single module may be separated into more than one module. It is noted that modules directed to example embodiments have been shown in the payment system 102. However, the payment system 102 may embody other modules (not shown) that are may be optional or not required by example embodiments.

The login module 302 manages the login of owners into their respective accounts. In example embodiments, the login module 302 may receive an identifier (e.g., a username, e-mail address) from a user. The login module 302 may also receive an authentication mechanism (e.g., password) to authenticate the identity of the user to the payment system 102. Using the identifier and the authentication mechanism, the login module 302 determines whether an account (e.g., master account 202 or proxy account 204) corresponds to the identifier and the authentication mechanism. If an account corresponds, then the user is allowed to access their account. However, if there is no corresponding account, then the user is denied access to any account, but may be allowed to re-enter login information.

The setup module 304 allows an owner of an account to manage their own account and to establish a proxy account from their account (e.g., a proxy account from a master account or a secondary proxy account from a proxy account). With respect to their own account, the owner may manage and link funding instruments to their account. By linking a funding instrument, any transactions initiated using the account may be processed using the funding instrument. For example, if the funding instrument is a credit card, a payment transaction initiated using the account will process a payment against the credit card. The owner may also access and view transaction history for their own account.

Using the setup module 304, the owner may establish one or more proxy accounts for their own use or for use by another. Upon providing an indication to establish a proxy account, the setup module 304 may provide a user interface (UI) to the owner to collect information for establishing the proxy account. The information may include one or more of an identifier for the proxy account, an authentication mechanism, access rights for the proxy account, an amount limit, an amount limit reset time period, restrictions for the proxy account, an expiration factor for the proxy account, and contact information for an owner of the proxy account. In one embodiment, the identifier for the proxy account may be the same as for the master account, but with a different authentication mechanism. Alternatively, the identifier for the proxy account may be set to any other identifier (e.g., name or e-mail address of owner of the proxy account) or authentication mechanism desired by the owner creating the proxy account.

The owner may also indicate how funding instruments of the master account are to be applied to transactions initiated by the proxy account. For example, the first $200 of the transaction is processed through a credit card and the rest of the amount of the transaction is processed through a bank account. Any combination of amounts and funding instruments may be used to fund the proxy account transaction.

With respect to the access rights, the master account owner may allow an owner of the proxy account to have access rights to view information on the master account funding instruments, to change, delete, or add funding instruments to the proxy account, or to view transaction history associated with the master account or the proxy account. Alternatively, the master account owner may limit or provide no access rights to view funding instruments, no access rights to view all transaction history, or access rights to only view transactions initiated by the proxy account. These latter access right embodiments may be useful when the proxy account is established for use by another individual.

Restrictions for the proxy account limit the usage of the proxy account. Example restriction terms may include categories of goods or categories of merchant that the proxy account owner is allowed to initiate transactions for or with. Alternatively, the restriction terms may indicate categories of goods or categories of merchants that the proxy account owner is not allowed to initiate transaction for or with. The restriction terms may be applicable to the full amount of the proxy account limit or be partially applicable. For example, the proxy account may have an amount limit of $500, but a restriction may be applied to $200 of that amount. In one embodiment, the UI allows the owner to specify an age group of the proxy account owner. Based on the age group, a drop down menu of restriction options may be provided to the owner from which the owner may select.

The expiration factor may comprise an expiration time, which is a predetermined time when the proxy account will expire. When the predetermine expiration time is reached, the proxy account is automatically closed. The expiration time may be set to any time frame (e.g., 3 day, 2 years) and may be adjusted at a later time by the individual that established the proxy account.

In alternative embodiments, the expiration factor may be set to when an amount limit is reached. For example, if the proxy account is established with an amount limit of $200, the proxy account may be set to expire upon the proxy account initiating $200 worth of transactions.

The proxy account may be established by the setup module 304 and the corresponding setup information and proxy account information may be stored in the database 112. Once the proxy account is established by the setup module 304, the proxy account owner may be notified regarding the existence of the proxy account. The setup module 304 may send a communication to the proxy account owner using the contact information provided by the master account owner.

The access module 306 manages account access by an account owner. When the account owner attempts to access information regarding their account, the access module 306 determines if the account owner has access rights. Thus, the access module 306 may access the database 112 and review the access rights for the account. If the account owner has access rights (e.g., to view history, to view, delete, add, or change funding instruments), then the access module 306 will allow access. However, if the account owner does not have access rights to perform a requested access action (e.g., to view history, to view, delete, add, or change funding instruments), the access module 306 denies the request.

The restriction module 308 manages restrictions for each account. When an account owner initiates a transaction, the restriction module 308 accesses restrictions stored for the account (e.g., from the database 112). The restriction module 308 then determines whether terms of the transaction violate any the restrictions. If a restriction is violated, then the transaction is denied by the restriction module 308.

The time module 310 manages the expiration of an account. The account may be established with an expiration factor. Alternatively, an expiration factor may be added to an existing account at any time via the setup module 304. The time module 310 determines if an account has reached a condition of the expiration factor. When the expiration factor is reached, the account is automatically terminated. The expiration factor may be an expiration date, an expiration duration (e.g., proxy account active for 100 days), or an expiration amount (e.g., the account expires upon reaching the amount limit established for the proxy account).

The transaction module 312 manages execution of transactions. Initially, the transaction module 312 receives a transaction request which is initiated using an account. The transaction module 312 may work with the restriction module 308 to determine if the transaction request may be processed. Assuming no restrictions are violated, the transaction module 312 checks for any amount limits for the account from which the transaction request was received. If the amount limit is not exceeded, the transaction module 312 executes the transaction. However, if the amount limit is exceeded, the transaction request may be denied. Execution of the transaction may comprise debiting a financial instrument of a master account for a specified amount and forwarding the funds to a receiving account.

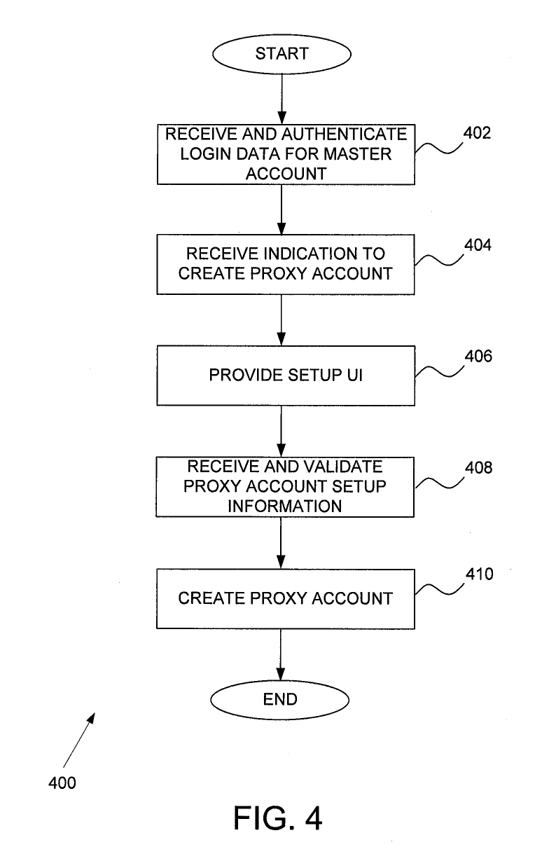

FIG. 4 is a flow diagram of an example high-level method 400 for creating a proxy account. In operation 402, login authentication is performed by the login module 302. As such, an identifier and corresponding authentication mechanism may be received from the owner. It is noted that a user may establish multiple accounts having the same identifier but different authentication mechanisms. Therefore, the login module 302 verifies the identifier/authentication mechanism combination and determines a corresponding account.

Upon receiving an indication to create a proxy account in operation 404, a proxy account setup UI is provided to the client device of the owner in operation 406. In one embodiment, the setup module 304 provides the proxy account setup UI. The setup UI allows the owner to provide information for establishing the proxy account. The information may include one or more of an identifier for the proxy account, an authentication mechanism, access rights for the proxy account, an amount limit, restrictions for the proxy account, an expiration factor for the proxy account, and contact information for the owner of the proxy account.

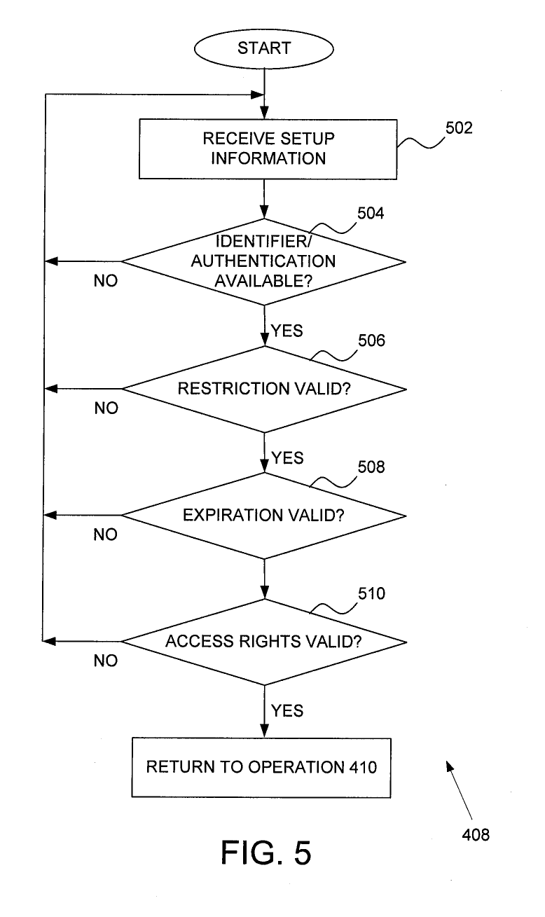

The information is received and validated in operation 408. Operation 408 will be discussed in more detail in connection with FIG. 5. Upon validation of the information, the proxy account is created in operation 410. The established proxy account is linked to the master account and the corresponding information may be stored in a database (e.g., database 112). If the proxy account owner is not the same as the owner of the master account that created the proxy account, a communication may be sent to the proxy account owner notifying them of the new proxy account. In example embodiments, the communication may include the identifier and authentication mechanism established for the proxy account.

FIG. 5 is a flow diagram of an example method (e.g., operation 408) for receiving and validating proxy account setup information. In operation 502, the setup information is received by the setup module 304. The setup information is then validated. Based on successful validation, the proxy account is created.

A determination is made in operation 504 as to whether the identifier/authentication mechanism combination is available. In example embodiments, the setup module 304 verifies the identifier/authentication mechanism combination is available by checking a database (e.g., database 112) containing information for existing accounts. In one embodiment, the identifier for the proxy account may be the same as for the master account, but with a different authentication mechanism. Alternatively, the identifier for the proxy account may be set to any other identifier (e.g., name or e-mail address of owner of the proxy account) or authentication mechanism desired by the owner creating the proxy account. If the combination is already being used as a login for another account in the payment system 102, then the combination is denied and the user is requested to provide a different combination.

In operation 506, any restrictions that are provided are validated. Restrictions for the proxy account limit the usage of the proxy account. Example restriction terms may include categories of goods or categories of merchant that the proxy account owner is allowed to initiate transactions for or with. Alternatively, the restriction terms may indicate categories of goods or categories of merchants that the proxy account owner is not allowed to initiate transaction for or with. The restriction terms may be applicable to the full amount of the proxy account limit or be partially applicable. In operation 506, the setup module 304 ensures that the restrictions are applicable to the proxy account being created. For example, if the proxy account is established with an amount limit of $200, then a restriction of $250 is not valid. In some embodiments, no restrictions may be provided when establishing the proxy account and operation 506 may be omitted.

In operation 508, the expiration factor is validated. The expiration factor may be an expiration time identifying a predetermined time when the proxy account will expire. When the predetermine expiration time is reached, the proxy account is automatically closed. The setup module 304 ensures that the expiration time (e.g., date) is a valid date (e.g., February 30^{th} does not exist) and that the expiration time has not already past. In some embodiments, no expiration time may be provided when establishing the proxy account and operation 508 may be omitted.

In operation 510, the setup module 302 validates whether the access rights are applicable to the proxy account. With respect to the access rights, the owner may allow or deny an owner of the proxy account access rights to view information on the master account funding instruments, to change, delete, or add funding instruments, or to view transaction history (e.g., if the proxy account is established for the master account owner's own use). In some embodiments, no access right inputs may be provided in establishing the proxy account. In this case, operation 510 may be omitted or default access rights may be applied. The default access rights may, in one embodiment, provide no access rights to view transaction history or funding instruments of the master account.

Once the inputs are validated, the proxy account is established (returning to operation 410). The input information of the established proxy account is stored in the database 112 so that subsequent transactions may be verified against the stored information. It is noted that the method 500 of FIG. 5 is an example embodiment, and alternative embodiments may perform the operations of the method 500 in a different order, remove operations, or combine operations.

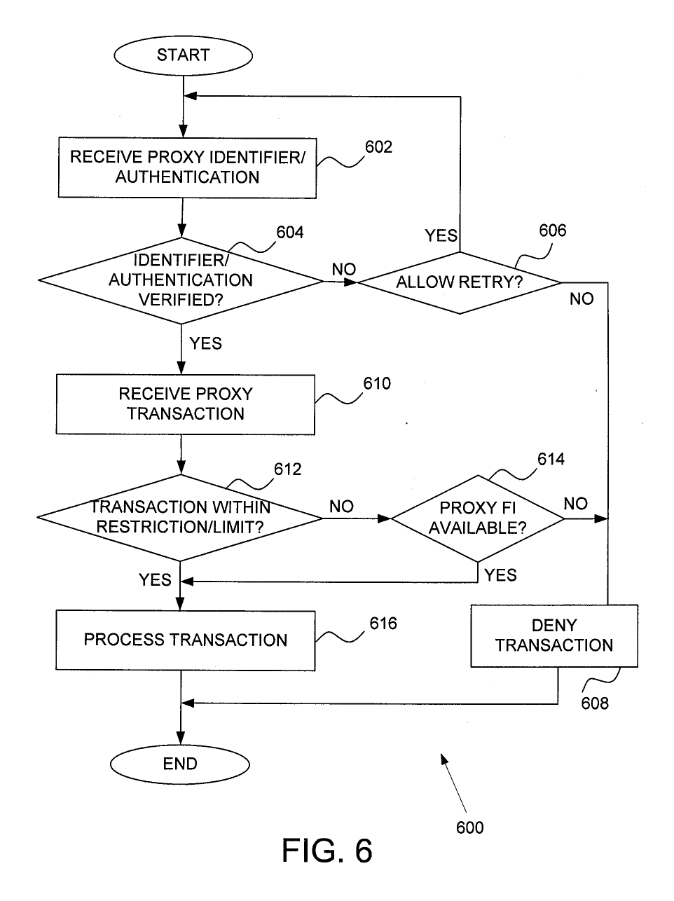

FIG. 6 is a flow diagram of an example method 600 for processing a transaction initiated by a proxy account. In the example of FIG. 6, the proxy account owner logs in with the payment system 102 prior to initiating a proxy transaction. As such, in operation 602, a proxy account identifier and authentication mechanism is received from the proxy account owner. The identifier/authentication mechanism combination is verified in operation 604. In example embodiments, the login module 302 determines whether a proxy account corresponds to the identifier/authentication mechanism combination.

If a proxy account does not correspond to the identifier/authentication mechanism combination, a determination may be made at operation 606 as to whether the user is allowed to retry their login. For example, if the user has already exceeded a number of login attempts (e.g., three attempts), the login module 302 may not allow any further attempts (e.g., until alternative verification information is received or until a certain time period is past) and the user is not allowed to proceed with the transaction at operation 608. Alternatively, the user may be allowed to retry their login attempt and the method 600 proceeds to operation 602.

Once the identifier/authentication combination is verified and the account identified by the login module 302, the proxy transaction information may be received in operation 610. For example, once the proxy account owner logs into their account, a UI may be provided to the owner by the transaction module 312 for entry of the transaction information.

The transaction information is then reviewed in operation 612 to determine if the transaction is within any restrictions or limitations set for the proxy account. As such, the restriction module 308 or the transaction module 312 may access restriction information corresponding to the proxy account and determine if the transaction violates any restrictions (e.g., not with a barred merchant or in a barred category). The transaction module 312 also determines if the transaction is within an amount limit established for the proxy account. If the transaction violates a restriction, then the transaction is denied in operation 608. Additionally, if the transaction exceeds the amount limit set for the proxy account and a determination is made at operation 614 (e.g., by the transaction module 312) that no supplemental funding instrument is linked to the proxy account, then the transaction is also denied in operation 608.

If the transaction satisfies all the restrictions and the amount limit established for the proxy account (or if a supplemental funding instrument is linked to the proxy account and the supplemental amount is available from the supplemental funding instrument), then the method 600 proceeds to operation 616 where the transaction is processed by the transaction module 312. In example embodiments, the transaction is processed against a funding instrument of the linked master account to the proxy account. In embodiments where the amount of the transaction is exceeds the amount limit established for the proxy account, the excess amount is supplemented by the supplemental funding instrument linked to the proxy account.

While the embodiment of FIG. 6 requires the proxy account owner to log into their proxy account to initiate a proxy transaction, alternative embodiments may not require a login prior to processing the proxy transaction. For example, a proxy transaction may be received from a secondary proxy account at a (primary) proxy account. In this example, the proxy transaction may not include an identifier or authentication for the (primary) proxy account. Instead, the method 600 will start at operation 610.

### Modules, Components, and Logic

Additionally, certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Example Machine Architecture and Machine-Readable Medium

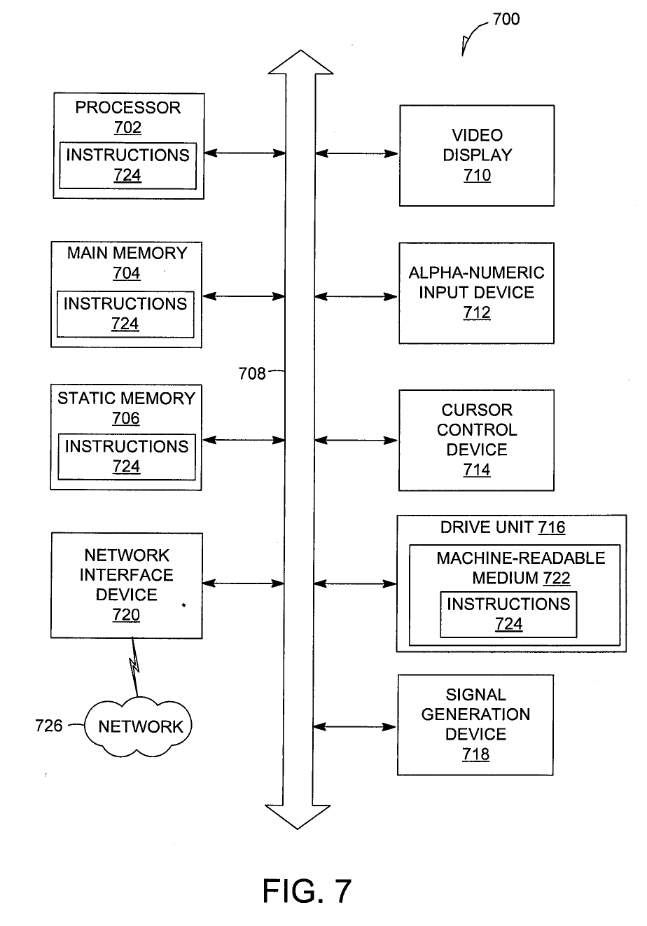

With reference to FIG. 7, an example embodiment extends to a machine in the example form of a computer system 700 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 may include a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). In example embodiments, the computer system 700 also includes one or more of an alpha-numeric input device 712 (e.g., a keyboard), a user interface (UI) navigation device or cursor control device 714 (e.g., a mouse), a disk drive unit 716, a signal generation device 718 (e.g., a speaker), and a network interface device 720.

### Machine-Readable Storage Medium

The disk drive unit 716 includes a machine-readable storage medium 722 on which is stored one or more sets of instructions 724 and data structures (e.g., software instructions) embodying or used by any one or more of the methodologies or functions described herein. The instructions 724 may also reside, completely or at least partially, within the main memory 704 or within the processor 702 during execution thereof by the computer system 700, with the main memory 704 and the processor 702 also constituting machine-readable media.

While the machine-readable storage medium 722 is shown in an example embodiment to be a single medium, the term “machine-readable storage medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories and optical and magnetic media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

### Transmission Medium

The instructions 724 may further be transmitted or received over a communications network 726 using a transmission medium via the network interface device 720 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
receiving a transaction request initiated through a proxy account, the proxy account being a dependent, non-funded subaccount of a master account;
determining, using one or more processors, whether a transaction of the transaction request satisfies restrictions and an amount limit established for the proxy account; and
based on the transaction satisfying the restrictions and the amount limit, processing the transaction against a funding instrument of the master account.

2. The method of claim 1, further comprising allowing the proxy account to link a supplemental funding instrument to the proxy account.

3. The method of claim 2, further comprising;
processing the transaction against the funding instrument of the master account for the amount limit; and
processing a remainder amount of the transaction against the supplemental funding instrument of the proxy account based on the transaction exceeding the amount limit.

4. The method of claim 2, further comprising shielding the supplemental funding instrument from access by an owner of the master account.

5. The method of claim 1, further comprising providing access to transaction history and funding instruments of the master account based on access rights established for the proxy account.

6. The method of claim 1, further comprising:
determining whether an expiration factor is reached; and
based on the expiration factor being reach, automatically terminating the proxy account.

7. The method of claim 6, wherein the expiration factor is an amount limit established for the proxy account.

8. The method of claim 6, wherein the expiration factor is an expiration time.

9. The method of claim 1, further comprising resetting the amount limit for the proxy account after a predetermined time period.

10. The method of claim 1, further comprising establishing the proxy account from the master account, the establishing comprising:
receiving proxy account setup information, the proxy account setup information including at least an identity/authentication combination and the amount limit for the proxy account;
validating the proxy account setup information; and
based on the validating, establishing the proxy account.

11. The method of claim 1, wherein the restrictions comprise at least one of an allowed category, an allowed merchant, a denied category, a denied merchant, an amount allowed for a category, or an amount allowed for a merchant.

12. The method of claim 1, further comprising establishing a lower level proxy account from the proxy account.

13. A system comprising:
a transaction module configured to receive a transaction request initiated through a proxy account, the proxy account being a dependent, non-funded subaccount of a master account; and
a restriction module configured to determine whether a transaction of the transaction request satisfies restrictions established for the proxy account,
the transaction module further configured to determine whether the transaction satisfies an amount limit and to process the transaction against a funding instrument of the master account based on the transaction satisfying the restrictions and the amount limit.

14. The system of claim 13, further comprising an access module configured to provide access to transaction history and funding instruments of the master account based on access rights established for the proxy account.

15. The system of claim 13, further comprising a time module configured to determine whether an expiration factor is reached and based on the expiration factor being reach, automatically terminating the proxy account.

16. The system of claim 13, further comprising a setup module configured to establish the proxy account from the master account and configured to establish a lower level proxy account from the proxy account.

17. A machine-readable storage medium in communication with at least one processor, the machine-readable storage medium storing instructions which, when executed by the at least one processor, performs a method comprising:
receiving a transaction request initiated through a proxy account, the proxy account being a dependent, non-funded subaccount of a master account;
determining whether a transaction of the transaction request satisfies restrictions and an amount limit established for the proxy account; and
based on the transaction satisfying the restrictions and the amount limit, processing the transaction against a funding instrument of the master account.

18. The machine-readable storage medium of claim 17, wherein the method further comprises:
determining whether an expiration factor is reached; and
based on the expiration factor being reach, automatically terminating the proxy account.

19. The machine-readable storage medium of claim 17, wherein the method further comprises resetting the amount limit for the proxy account after a predetermined time period.

20. The machine-readable storage medium of claim 17, wherein the method further comprises:
allowing the proxy account to link a supplemental funding instrument to the proxy account; and
based on the transaction exceeding the amount limit, processing the transaction against the funding instrument of the master account for the amount limit and processing a remainder amount of the transaction against the supplemental funding instrument of the proxy account.
